(19) United States
(12) Patent Application Publication
(10) Pub. No.: US 2012/0253878 A1
(43) Pub. Date: Oct. 4, 2012

(54) METHOD AND SYSTEM FOR SCHEDULING PARATRANSIT SERVICE

(75) Inventor: Keith W. Forstall, Lexington, MA (US)

(73) Assignee: Trapeze Software Inc., Mississauga (CA)

(21) Appl. No.: 13/074,887

(22) Filed: Mar. 29, 2011

(51) Int. Cl. G06Q 10/00

(52) U.S. Cl. 705/7.22; 705/7.25

(57) ABSTRACT

A method and system for scheduling paratransit service are provided. Demand metrics in a database are identified for a set of past days matching the type of a day for which service is being planned. The database is stored in storage of a computer system. One of the set of past days whose demand metrics correspond to a target demand level to be satisfied is selected. A service schedule for the day is initialized using actual service provided for the one past day. The service schedule is adjusted for the service fit metrics for the one past day stored in the database. The service schedule for the day is outputted.

### FIELD OF THE INVENTION

The present invention relates generally to paratransit. More particularly, the present invention relates to a method and system for scheduling paratransit service.

### BACKGROUND OF THE INVENTION

Traditional public transit provisioning is known. A set of fixed routes is established for a metropolitan area being served. For each fixed route, there is a physical route being traveled by public transit vehicles, including the scheduled stops along the physical route, as well as a time schedule for when a transit vehicle is expected to be at a particular scheduled stop. The fixed routes are established based on the population distribution and the street layout of the metropolitan area, as well as the perceived demand for service for that population. Various systems have been developed to solve the problems that public transit organizations face in providing fixed-route service. Such problems include the revision of physical routes, the adjustment of the frequency of service along the fixed routes, etc.

Paratransit, or dial-a-ride, is an alternative mode of flexible on-demand passenger transportation that does not follow fixed routes or schedules. Typically vans or mini-buses are used to provide paratransit service, but shared ride taxis and jitneys can also be used. Paratransit services operated by public transit organizations are often fully demand-responsive transport, wherein on-demand call-up curb-to-curb or door-to-door service from any origin to any destination in a service area is offered. Such services are typically provided to serve people in the metropolitan area that are physically-challenged, who are provided transportation services in accordance with a public or non-profit social service program of some type, etc.

While, with fixed-route public transit, a level of service is determined to meet the needs of the majority of the people using the service, the goals differ for the level of service provided to paratransit users. It is generally desirable to ensure that users requesting service receive service because their options are more limited. If paratransit service is not made available to some users, strong penalties may be imposed on the transit organization by the government, and the transit organization's public image may be negatively impacted.

As a result, the service in over-provisioned to ensure that all demand is met almost all of the time. This is evidenced by metrics of both passengers per to vehicle hours and passengers per revenue vehicle hour for most paratransit services. In many cases, the “pay-to-platform” ratio, corresponding to the amount of time a vehicle operator is paid versus the amount of time the vehicle operator is actually serving customers, is often as high as 1.6. A goal of the paratransit service scheduling solution developed is to assist in better understanding demand and how to best serve it, whilst potentially reducing the amount of time that vehicle operators are idle/not serving customers (i.e., reducing the pay-to-platform ratio). For private operators, any cost savings achieved directly impact the bottom line. For public operators, better understanding how to serve demand for paratransit can translate into the ability to handle growth in demand without pro rata increased costs.

Expected demand can vary significantly from actual demand experienced. Paratransit does not have the same capacity that fixed-route transit has for absorbing fluctuations in passenger volumes.

Once a demand level to be satisfied has been selected, modeling the service to meet that demand level can present a complex problem. Different vehicle types can have different abilities for serving ride requests as a result of their capacity, configuration and even their ability to maneuver on residential roads or private driveways.

It is therefore an object of the invention to provide a novel method and system for scheduling paratransit service.

### SUMMARY OF THE INVENTION

According to an aspect of the invention, there is provided a method for scheduling paratransit service, comprising:

identifying demand metrics in a database for a set of past days matching the type of a day for which service is being planned, said database being stored in storage of a computer system;

selecting one of said set of past days whose demand metrics correspond to a target demand level to be satisfied;

initializing a service schedule for said day using actual service provided for said one past day stored in said database;

adjusting said service schedule for service fit metrics or said one past day stored in said database; and

outputting, said service schedule.

The demand metrics can include the number of passenger pick-ups and drop-offs.

The service fit metrics can include lateness metrics. The lateness metrics can include late pick-up and/or drop-off events.

The service fit metrics can include slack metrics. The slack metrics can include the amount of vehicle idle time.

The method can include adjusting the service schedule for expected growth.

The selecting can include selecting the one past day at least partially based on a fit level between the demand metrics for the one past day and a general demand pattern for the type of the day. The general demand pattern can correspond to the average of the demand metrics for the set of past days.

The method can include:

discarding said selected one past day if a fit level between said demand metrics for said selected one past day and a general demand pattern for the type of said day is unsatisfactory; and

selecting a remaining one of said set of past days whose demand metrics correspond to a target demand level to be satisfied.

The target demand level to be satisfied can correspond to a ratio of the time for which all expected demand is to be met.

In accordance with another aspect of the invention, there is provided a system for scheduling paratransit service, comprising:

a database stored in storage of a computer system, said database storing demand metrics and service metrics for past days, said service metrics including actual service provided and service fit metrics; and

service scheduling software executing on said computing system, said service scheduling software identifying said demand metrics in said database for a set of said past days matching the type of a day for which service is being scheduled, mapping a target demand level to be satisfied onto said demand metrics for said set of past days, initializing a service schedule for said day using said actual service provided stored in said database for a selected past day whose demand metrics generally correspond to said target demand level, adjusting said service schedule for said service fit metrics and slack metrics for said one past day stored in said database, and outputting said service schedule for said day.

The demand metrics can include the number of passenger pick-ups and drop-offs.

The service fit metrics can include lateness metrics. The lateness metrics can include late pick-up and/or drop-off events.

The service fit metrics can include slack metrics. The slack metrics can include the amount of vehicle idle.

The service scheduling software can adjust the service schedule for expected growth.

The service scheduling software can select the one past day at least partially based on a fit level between the demand metrics for the one past day and a general demand pattern for the type of the day. The general demand pattern can correspond to the average of the demand metrics for the set of past days.

The service scheduling software can discard the selected one past day if a fit level between the demand metrics for the selected one past day and a general demand pattern for the type of the day is unsatisfactory, and select a remaining one of the set of past days whose demand metrics correspond to a target demand level to be satisfied.

The target demand level to be satisfied can correspond to a ratio of the time for which all expected demand is to be met.

### BRIEF DESCRIPTION OF THE DRAWINGS

Embodiments will now be described, by way of example only, with reference to the attached Figures, wherein:

FIG. 1 shows a schematic representation of a computer system for scheduling paratransit service in accordance with an embodiment of the invention;

FIG. 2 is a flowchart of the general method for scheduling paratransit service using the computer system of FIG. 1; and

FIG. 3 is a chart of total trips for each Wednesday in a date range being analyzed;

FIG. 4 is a table of the total trips for the Wednesdays shown in FIG. 3 after reordering;

FIG. 5 shows the number of trips for each time interval for the selected past day and the average number of trips for each time interval for all past days in the date range analyzed, as shown in FIG. 3; and

FIG. 6 shows the distribution of trips over the time intervals for the selected past day and the distribution of the average number of trips for each time interval for all past days in the date range analyzed, as shown in FIG. 5.

### DETAILED DESCRIPTION OF THE EMBODIMENTS

Paratransit service scheduling is markedly different than for fixed-route transit. In fixed-route transit, a number of fixed routes are established and the type of vehicle that travels a particular fixed route is generally not varied. The frequency of service along the fixed route is reduced to decrease costs during periods of lower demand. During almost all of the time, however, the frequency of service provided results in few vehicles being tilled to their capacity. As a result, fixed route service can readily handle unexpected fluctuations in passenger volume.

In contrast, in paratransit, vehicles are typically smaller, enabling them to carry fewer passengers. Further, as paratransit involves picking up and dropping off passengers along varying routes, vehicles providing paratransit service cannot typically increase their ability to service additional passengers. As a result, in order to have a better chance of serving fluctuations, paratransit organizations have to increase the number of vehicles/operators.

Demand for paratransit services tends to vary by day of the week rather than being fairly constant throughout the five business days in a week as it does for fixed-route service. In order to provide a level of service that enables the paratransit operator to serve most demand, paratransit operators must provide enough aggregate capacity, or service, to meet the somewhat random set of pick-up and drop-off times and addresses. While it may be acceptable to not have planned fixed-route service that can handle the requirements of a particular passenger, the very nature of paratransit leads to a high desirability to meet demand in almost every case. In some cases, excess demand can be shifted to other transportation providers, such as taxis. As the majority of the cost of other such transportation is traditionally picked up by the paratransit organizations, and as such costs are significantly higher than providing such service within the paratransit organizations, however, it is desirable to minimize the amount of passengers shifted to other transportation providers.

The approach developed for scheduling paratransit service is to select a single past day from a set of past days matching the day type of the day for which service is being planned. The particular past day is selected from the set of past days based on its demand metrics, which correspond to a target demand level. If the demand metrics for the selected past day are deemed acceptable, then the actual service provided for that particular past day is used to initialize a target service schedule (that is, a specification of vehicle requirements by time of day), which may be subsequently adjusted for metrics relating to how the actual service provided was appropriate to meet the demand for that past day.

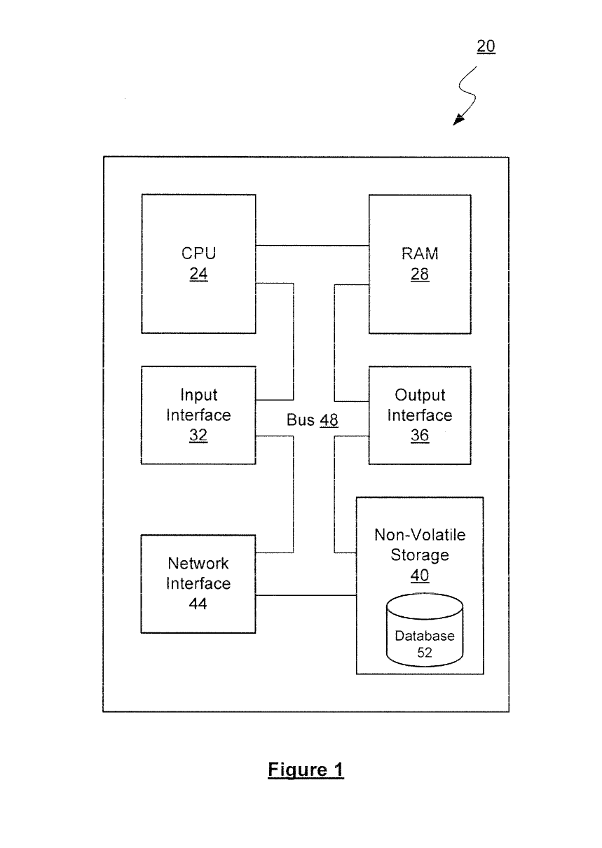

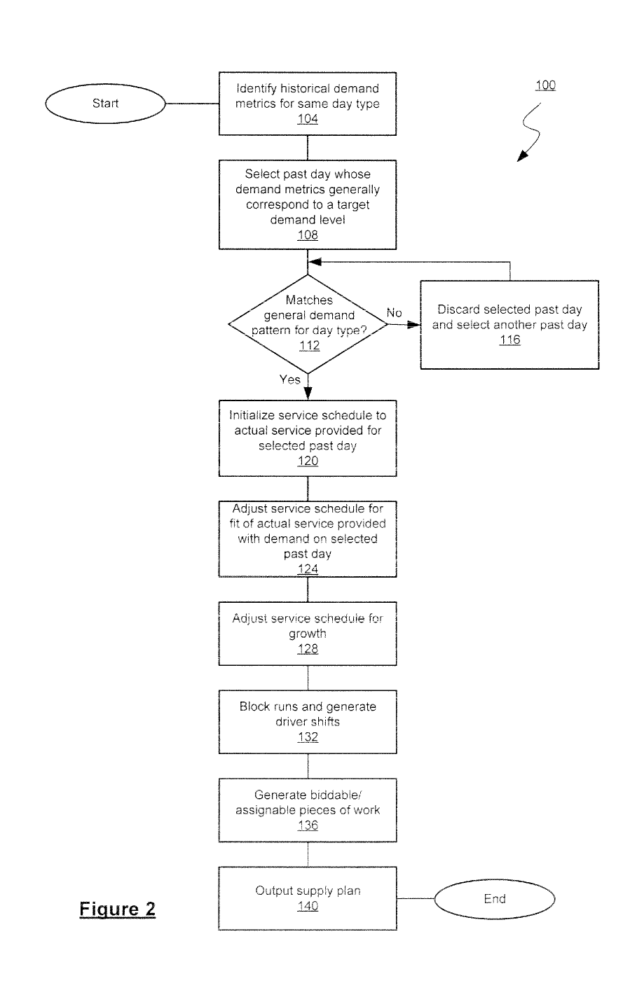

FIG. 1 shows a computer system 20 for scheduling paratransit service in accordance with an embodiment of the invention. As shown, the computer system 20 has a number of components, including a central processing unit (“CPU”) 24, random access memory (“RAM”) 28, an input interface 32, an output interface 36, non-volatile storage 40, a network interface 44 and a local bus 48 enabling the CPU 24 to communicate with the other components. The CPU 24 executes an operating system and computer-executable instructions in the form of software that implements the method as will be described. RAM 28 provides relatively responsive volatile storage to the CPU 24. The input interface 32 allows for input to be received from one or more devices, such as a keyboard, a mouse, etc. The output interface 36 enables the CPU 24 to present output to a user via a monitor, a speaker, etc. Non-volatile storage 40 stores the operating system and the aforementioned computer-readable instructions, as well as data used by both. The network interface 44 permits communication with other systems. During operation of the computer system 20, the operating system and the computer-readable instructions may be retrieved from the non-volatile storage 40 and placed in RAM 28 to facilitate execution.

A database 52 is maintained by the computer system 20 in non-volatile storage 40. The database 52 acts as a registry for demand and service metrics collected by the paratransit service for a plurality of past days. The demand metrics include the number of customer events (pick-ups and drop-offs) for each past day time interval, typically 15 or 30 minutes in length. The service metrics include the actual service provided for the past days as well as service fit metrics. The actual service provided identifies the number of vehicles for each vehicle type and drivers that were active for each time interval. The service tit metrics provide a measure of how much the actual service provided exceeded or fell short of demand. In particular, the service fit metrics include lateness metrics and slack metrics. The lateness metrics correspond to the number of late passenger pick-ups and/or drop-offs by time interval. The slack metrics measure the total number of times a vehicle was idle for more than x minutes for each time interval. The data for each past day is associated with the past day to enable filtering of the data by day or day type.

The computer system 20 executes software for scheduling paratransit service that is stored in the non-volatile storage 40. The paratransit service scheduling software includes a number of components and services. In particular, the paratransit service scheduling software includes a demand analysis tool, a service scheduling tool, a blocking and run-cutting tool and a rostering tool. The demand analysis tool identifies a set of past days matching the day type of the day for which service is being planned, retrieves demand metrics for the set of past days, and maps a target demand level to be satisfied onto the demand metrics for the set of past days. The user selects one of the past days generally corresponding to the target demand level and having a demand distribution representative of the general pattern of demand distribution for the set of past days. The service scheduling tool initializes a service schedule based on the actual service provided for the selected past day and adjusts it based on mismatches between the actual service provided and the demand experienced on the selected past day, as measured by the service fit metrics. The blocking and run-cutting tool builds runs that best fit the service schedule in order to reduce the amount of excess capacity, and generates driver shifts from the resulting paratransit runs while observing certain constraints such as maximum percent split driver shifts and maximum spread time per driver shift. Runs are vehicle assignments from pull-out to pull-in. Driver shifts are periods worked by drivers and generally consist of one or more runs on a given day. The rostering tool assembles the driver shifts into biddable/assignable pieces of work representing an appropriate number of hours of work over a one or two week period.

The paratransit service scheduling software is an application that provides a web-based user interface allowing the user to set parameters and constraints, launch the demand analysis tool and the service scheduling tool, and edit the recommended service schedule interactively as necessary. It then allows the user to launch the blocking and run-cutting tool and the rostering tool, and review the results. In addition, the user interface allows acceptance and export of the final results into one or more paratransit scheduling solutions so that the new service schedule can be deployed into a production or test scheduling environment.

The user interface itself includes a logon screen for restricting access to authorized personnel. An options screen enables input of the following:

Database location: This enables specification of the location of the database 52.
Analysis date range: This section permits a user to select the historical period over which demand and service is analyzed. The range can be selected by specifying a range length, such as two years, or start and end dates for the range.
Exception dates: This enables selection of exception dates (holidays or other days that the user wishes to exclude due to extraordinary circumstances such as snow days when non-critical service is cancelled) to be excluded from the analysis.
Group all weekdays together: A checkbox enables a user to group all weekdays together as the same day type. If checked, all weekdays treated equally, with demand being estimated using all weekdays. By default, this box is unchecked, thus treating each weekday separately. As many paratransit operators have patterns of usage that vary by weekday (Wednesdays are often busier than other weekdays, for example), it can be desirable to perform the analysis treating each day of the week separately.
Trip categorization: This is a set of checkboxes that allows inclusion of no-show trips, cancelled trips, and/or unscheduled trips in the demand analysis. Unscheduled trips are trips that cannot be satisfied and are therefore unscheduled. Although these trips may not be serviced, the requests can be recorded to enable measurement of unsatisfied demand. For unscheduled trips, the request time is used and the average trip length is used to project a time for the non-request end of each trip. Additional checkboxes enable the inclusion or exclusion of trips by subtype. This is useful if, for example, denied and refused trips are categorized by subtype. Further, the analysis can be limited to trips assigned to specific providers. This is useful both for complex sites as well as for sites that routinely outsource a portion of their demand to taxis. By selecting the appropriate checkboxes, the analysis can be performed exclusively on cancelled trips, if so desired. If a time-based pattern of cancellations can be observed, it can allow the scheduling of service not on the projected demand, but on the net demand after foreseeable cancellations have been factored in.
Growth rate: This field permits a user to specify an expected growth rate to adjust scheduled service by. As scheduled service is determined using historical data, the scheduled service is adjusted for growth to the day for which service is being scheduled. Setting the rate of growth to zero enables growth to be ignored, and setting growth to a negative value implies negative growth.
Target demand level: The target demand level can be specified in a number of manners, such as a ratio of the time for which all projected demand is to be satisfied, or via cost functions for specifying a cost for satisfied and unsatisfied demand. In this embodiment, the target demand level is set as a percentage of days for which all projected demand is to be satisfied.

In addition, the user interface also allows the user to specify the available service in tends such as the available capacity type configurations and the maximum concurrent number of runs that can be supplied of each capacity type.

A launch screen permits the user to individually launch the demand analysis tool, the service scheduling tool, the blocking and run-cutting tool, and the rostering tool. A wizard approach can also be used to walk a user through the process of building runs/driver shifts. A further dialog allows the user to update a standard paratransit scheduling application with the paratransit run/driver shift information that is created. This is accomplished via wrapping the blocking/run-cutting/rostering tools as a service that can be called by the application. In addition, the paratransit service scheduling software includes a service to enable interaction with the various components via a graphical interface.

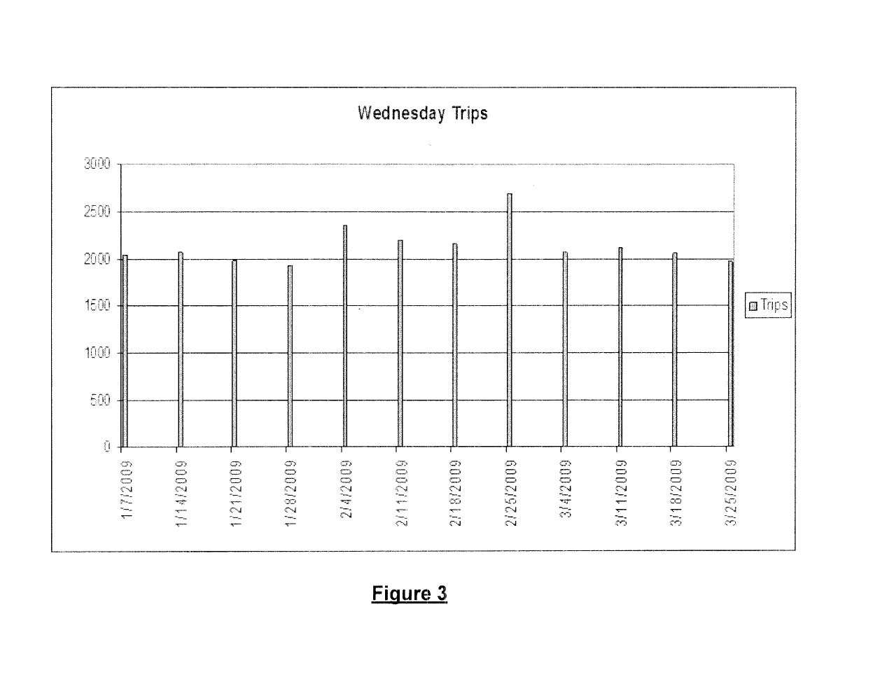

The general method for scheduling paratransit service for a particular day using the computer system 20 is shown generally at 100 in FIG. 2. The method 100 commences with an identification of demand metrics for past days of the same day type as the day for which service is being scheduled (step 104). The demand analysis tool identifies a set of past days matching the day type for which service is being scheduled. Exception dates are excluded from the set of past days. Selection of the date range over which to analyze demand is important to the success of the process. Paratransit is often seasonal in nature. Therefore, a good way to look at expected demand for a pending summer season, for example, can be to look at demand for the same period of time in the prior year. The demand metrics in the database 52 for the identified set of past days include pick-up and drop-off events by time interval for each past day in the set.

FIG. 3 shows a chart of the number of trips for a set of past days that match the day type of a day for which service is being planned in an exemplary scenario. In this exemplary scenario, paratransit service is being planned for a Wednesday occurring in the first quarter of 2010, making it desirable to model demand and service on a past day from the first three months of the previous calendar year. The analysis date range specified is the first three months of 2009 and all weekdays are not grouped together. Further, the target demand level specified is to meet all demand 90% of the time. As a result, the set of past days includes all past days of the same day type (i.e., Wednesdays) in the first three months of 2009.

Returning back to FIG. 2, the demand analysis tool allows the user to identify and select a particular past day from the set of past days identified at 104 whose demand metrics best match the specified target demand level (108). The demand analysis tool totals the passenger pick-up and drop-off events for each past day in the set and divides the total by two to determine the total trip count. In addition, based on the options selected on the options screen, the no-show trips, cancelled trips and unscheduled trips can be added to the total trip count. The past days are then sorted based on the total passenger pick-ups and drop-offs.

Once the adjusted total trip count for each past day in the set has been determined, the demand analysis tool transmutes the target demand level for the day for which service is being scheduled into a number of projected trips to be satisfied for the day. For example, if the target demand level is stated as a percentage of days (x %) for which all projected demand is to be satisfied, the demand analysis tool determines which of the past days being analyzed corresponds to the (1−x %)th percentile in terms of the adjusted total trip count.

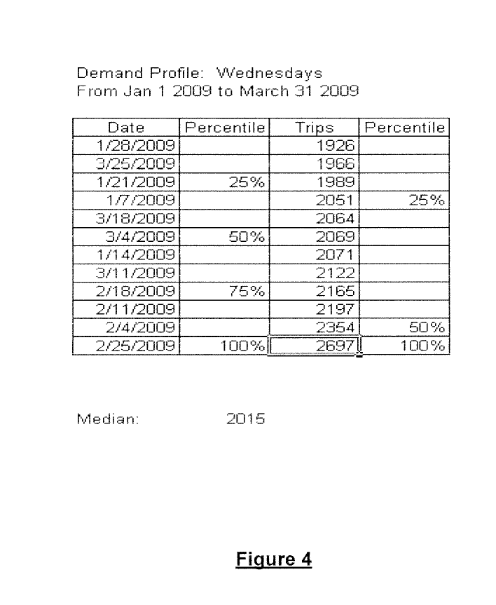

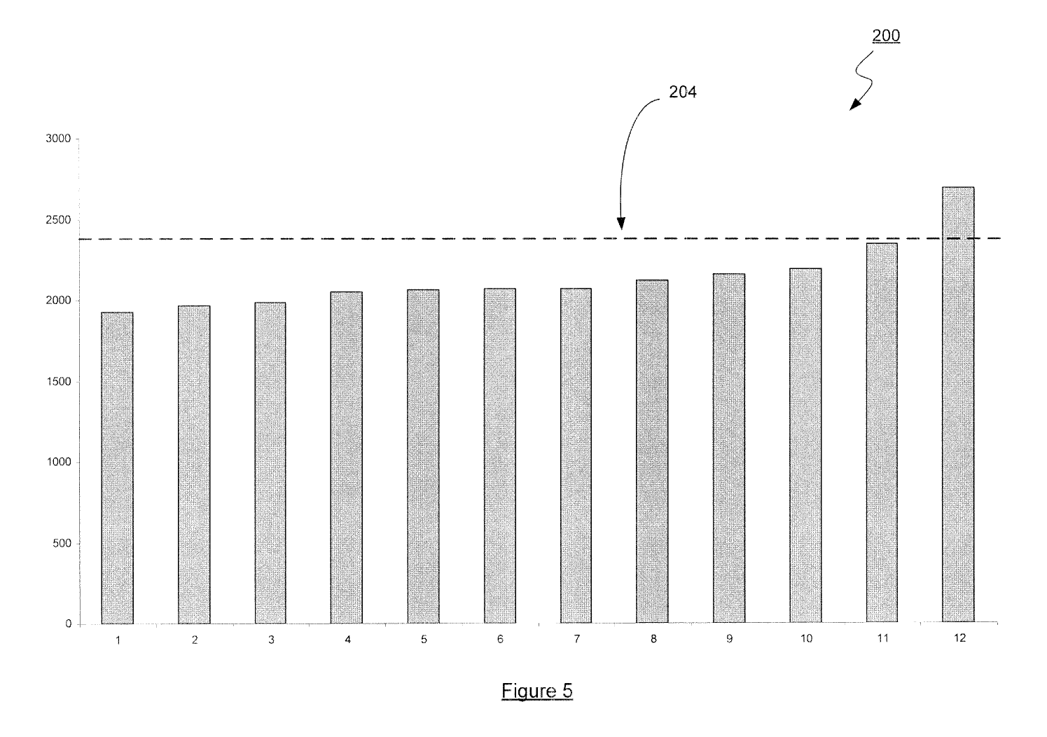

FIG. 4 shows a table of the number of trips for the set of past days shown in FIG. 3, after ordering the past days by the magnitude of the number of trips.

FIG. 5 shows a graphical representation 200 of the past days sorted by the total number of passenger trips for each past day as generated and presented by the demand analysis tool. The demand analysis tool maps the target demand level onto the graphical representation to enable a user to visualize which past days generally correspond with the target demand level. The user can then select a past day generally corresponding to the target demand level in the graphical representation.

Returning again to FIG. 2, it is determined if the distribution of demand metrics for the selected past day match the general demand pattern for the set of past days (112). In order to do so, the demand analysis tool first determines the percent of total passenger pick-ups and drop-offs for each time interval during the past day selected by the user at 108. The times of both pick-ups and drop-offs are considered when computing trip counts by time interval. Passenger trips are attributed to a time interval based on the sum of all pick-ups and drop-offs, divided by two. This helps to properly recognize the commitments at the end of each run when all pick-ups have been completed but the run is still busy with drop-offs.

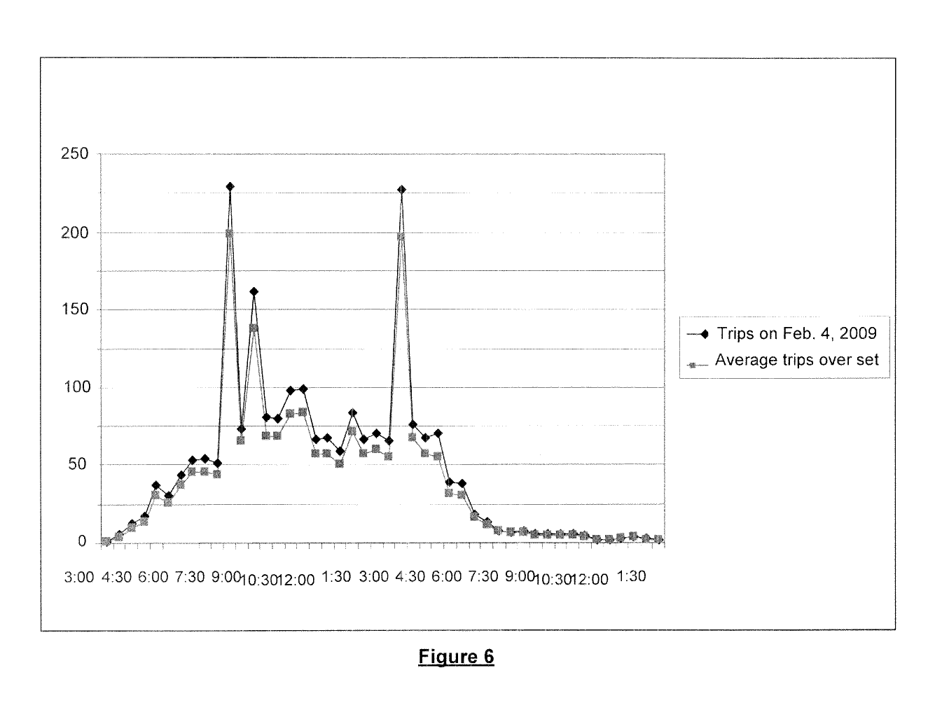

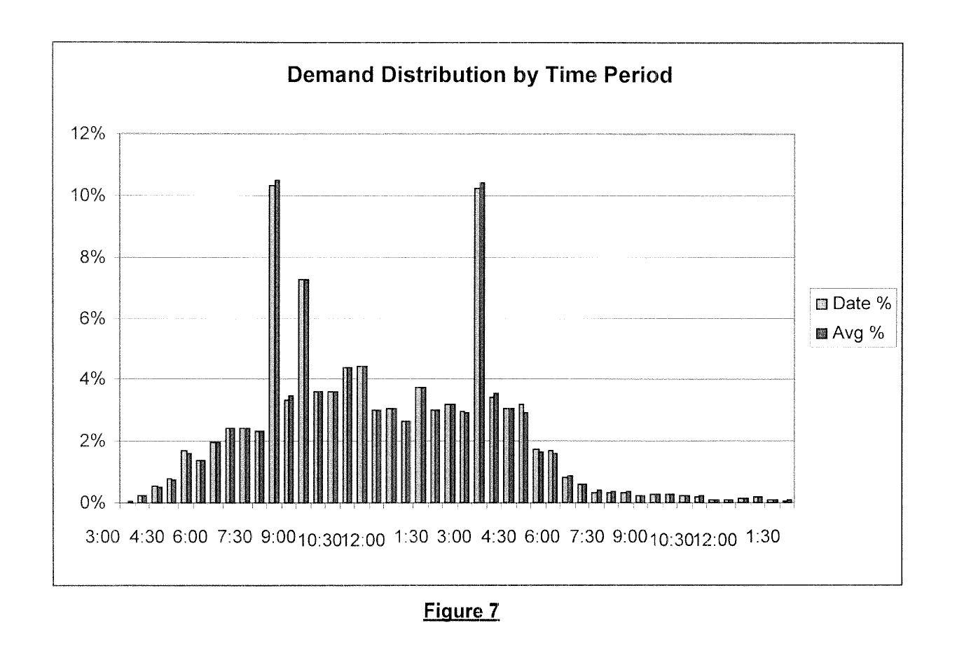

FIG. 6 illustrates the passenger trip counts by time interval for the selected past day versus the average trip count by time interval for the set of past days. As can be seen, there can be significant differences between the passenger trip counts for the selected past day and the average passenger trip counts over the set of past days for each time interval. At this point, however, the “pattern” or distribution of passenger trips throughout the day is of interest.

The demand analysis tool graphically presents the distribution of passenger trips throughout the selected past day to a general demand pattern identified for the day type as represented by the set of past days. The general demand pattern for the day type being modeled is determined by averaging the adjusted trip counts for each time interval in the set of past days.

FIG. 7 shows a chart of the percent of the total number of trips occurring within each 30-minute time interval for the selected past day and the percent of the average number of trips for all past days in the set within each time interval. This chart is presented to the user upon selection of a past day from the set of past days presented to him via the graphical representation as shown in FIG. 5. As can be seen, in this ease, the percents of the total number of trips occurring within each time interval for the selected past day are relatively close to those for the average past day in the set. While FIG. 6 showed absolute magnitudes, the bars in FIG. 7 illustrate relative magnitudes. The user can configure the chart to alternatively be a line graph.

The demand analysis tool enables the user to visually compare the percent of the total trip count for the selected past day for each time interval to those of the average number of trips for all past days in the set within each time interval. If the user is satisfied based on the overlay that the distribution of trips for the selected past day sufficiently matches the general demand pattern for the day type, then he can accept the selected past day as representative.

Returning again to FIG. 2, if the user rejects the selected past day, the selected past day is discarded and another particular past day is selected by the user (116). The user is presented with the sorted list of past days again together with the mapped target demand level to enable his selection of another past day for further analysis. After selecting another particular past day, the method returns to 112, at which the user determines if the demand pattern for the newly-selected past day selected at 116 matches the general demand pattern for the day type being modeled.

If, instead, the user determines that the distribution of trips for the selected past day matches the general demand pattern for the day type, selection of one of the set of past days upon which the service schedule will be modeled is complete. The demand analysis tool can generate as output a table of expected demand, in number of trips, by time interval for the day for which service is being scheduled, and a graphical view of the results.

Next, the service scheduling tool establishes an initial service schedule using the actual service provided on the selected past day (120). The demand analysis tool assumes that the projected demand for the day for which service is being scheduled is equal to the adjusted demand metrics for the selected past day. The service scheduling tool retrieves the service metrics from the database 52 for that particular past day and uses them as an initial service schedule.

The service scheduling tool then adjusts the initial service schedule for the service fit metrics for the selected past day (124). The service scheduling tool looks at the service fit metrics to determine how to adjust the initial service schedule to better match the actual demand. As previously noted, the service fit metrics include slack and lateness metrics. The slack metrics provide a measure of how much drivers were idle, and the lateness metrics provide a measure of how often passenger pick-ups (and, in some cases, drop-offs) were late by more than a user-specified period of time, such as five minutes.

The adjustment for slack metrics is based on a formula that reduces the number of vehicles required in any given time period by a user-adjustable percent of the number of runs that are identified to meet or exceed the user-specified number of minutes of slack within the time interval in question. For each time interval, every run is evaluated to determine the amount of slack time. The slack time ignores chunks of slack that are smaller than a user-definable minimum slack time threshold.

For example, suppose that the time interval is 15 minutes, the slack threshold is also 15 minutes, and the applied percent is 20%. If the nominal vehicle requirement is 100 vehicles in a particular time interval, but 20 of those vehicles are slack for the entire 15 minute period, then the vehicle requirement will be reduced by 20% of 20 vehicles, making the adjusted vehicle requirement 100−(0.2×20)=96 vehicles.

The adjustment for lateness metrics is based on a formula that increases the number of vehicles required in any given time interval by a user-adjustable percent of the number of runs that are identified to have met, or exceeded user-specifiable criteria for lateness within the time interval in question. The analysis compares the actual time of arrival with the end of the pick-up window provided to the passenger for every client event (pick-up or drop-off) on every run. If the actual time of arrival is after the end of the pick-up window by more than a user-defined threshold, then the run is considered late in the relevant time interval. A run is also considered late if there is a passenger on board who was picked up late, even if the actual pick-up occurred in a prior time period. From this, the number of late runs can be determined for each time interval. The number of additional runs added to the service schedule is equal to the number of late runs multiplied by a user-defined late run factor, and rounding the product up to the nearest whole number.

For example, suppose that the late threshold is 15 minutes, and seven runs operated late by more than this amount in the selected date/time interval. If the late run factor is 0.5, then 0.5×7=3.5, rounded up to four. Thus, four additional runs are added to the particular time interval in the service schedule to compensate for the lateness metrics.

Once the service schedule is adjusted for the service fit metrics, the service schedule is further adjusted for the expected growth rate (128). In particular, the service scheduling tool determines the period of time between the selected past day upon which service is being modeled and the day for which service is being scheduled, and applies the growth rate inputted by the user to the service schedule to accommodate for growth during this period.

The blocking and run-cutting tool takes the results of the service scheduling tool that is, the estimates of the number of vehicles required in service by time interval and day) and uses them to produce runs (vehicle blocks) and driver shills (132). The blocking and run-cutting tool takes into consideration the following constraints.
The number of runs on the road at any time of day cannot exceed the maximum pullout capability of the available vehicle fleet. The operator may remove this limitation in order to understand when to add vehicles to the fleet. In fact, parameters for new vehicle types not yet operated by the paratransit operator can be entered to determine if any should be bought where demand is high.
The maximum number of runs that can be scheduled to pull out in any one time interval.
The operator can specify the maximum number of total service hours (pull-out to pull-in). This can pose an insoluble problem, given the demand. It is common practice, however, particularly among sites that have the ability to divert demand to taxis or other undedicated resources. The goal in such a case can be to satisfy as much demand as possible given the maximum available hours, thus minimizing the number/cost of passenger trips that must be diverted, as the cost of these diverted trips is generally picked up by the paratransit operators.
The operator can specify various parameters that define different types of legal driver shifts. The different types of legal driver shifts form profiles. All runs are then constructed to conform to one or the profiles defined for a legal driver shift. This is expressed as a minimum driver shift length and a maximum driver shift length.
Driver shifts either qualify as a full time “straight” assignment of a single run or as a candidate to match two or more runs together according to rules that apply to full-time split shift rules. The operator can specify the maximum percent of runs that are too short for a straight shift and which therefore must be combined with other split type runs to form a daily driver shift.

The blocking and run-cutting tool obtains a number of inputs from the user, including the types of runs that the operator wishes to schedule. The user can define any number of distinct “legal” run types; that is, run types that the paratransit operator wants to build to comply with law, agreements, etc. For each distinct legal run type, the user can specify the minimum run length and the maximum run length.

Illustrated below is a legal run type table of four distinct run types defined by an operator. The first legal run type, labeled “Straight 10”, is a straight run of minimum length 9h45m and maximum length 10h15m. The second legal run type, labeled “Straight 8”, is a straight run of minimum length 7h30m and maximum length 8h00m. The third legal run type, labeled “Split 5”, is a split run of five hours in length. The fourth legal run type, labeled “Split 4”, is a split run of minimum length 3h45m and maximum length 4h15m. The designation of straight or split is used to indicate whether or not the run may be combined with another run to form a driver shift. The creation of a split driver shift (a driver shift consisting of two or more split runs) may be governed by rules limiting the amount of time between runs and/or the maximum elapsed time from the beginning of the first run to the end of the last run of the driver shift.

| Description | Type | Shortest | Longest |
|---|---|---|---|
| Straight 10 | Straight | 9 h 45 m | 10 h 15 m |
| Straight 8 | Straight | 7 h 30 m | 8 h 00 m |
| Split 5 | Split | 5 h 00 m | 5 h 00 m |
| Split 4 | Split | 3 h 45 m | 4 h 15 m |

Users can also specify the amount of time to assume as non-revenue from the pullout to the first available pick-up, as well as from the last drop-off to the pull-in. This is added to every driver shift.

If the proportion of straight driver shifts is below a minimum specified by the paratransit operator, split driver shifts are coupled together to form straight driver shifts until the minimum proportion is satisfied. The blocking and run-cutting tool analyzes pairs of driver shifts identified as being candidates for combining to form straight driver shifts according to the rules specified by the paratransit operator for spread times. In particular, the original driver shifts before time was appended by the blocking and run-cutting tool are looked at. If two driver shifts qualify for such analysis, the blocking and run-cutting tool considers combining the driver shifts by appending additional time between the driver shifts.

In order to meet the constraints of a legal driver shill as specified by the operator, in some cases, additional time is appended onto driver shifts. For example, if a driver shift length of 6h30m is calculated to meet demand, it can be desirable to append one hour on an end of the driver shill to make it a legal straight eight hour driver shift as per the above table.

In addition, user inputs permit a time allowance form formal lunch break policy, if so desired.

Once the minimum proportion of straight driver shifts is met, the coupling ceases and the coupled driver shifts generated by the blocking and run-cutting tool plus the straight and split driver shifts generated by the blocking and run-cutting tool, including the appended additional time, form the run-cut. The run-cut represents the proposed final service schedule.

The outputs of the blocking and run-cutting tool are as follows:
A tabular representation of runs, including start time and end time.
A graphical representation of runs, including start time and end time.
A tabular representation of driver shills, including: start time and end time.
A graphical representation of driver shifts, including start time and end time. Each driver shift is coded to show what type of driver shift it is. Additionally, the appended time may be colored differently to distinguish it from the other driver shift time.
A tabular summary of the solution, showing the number of driver shifts of each defined type.
A series of metrics that represent the efficiency of the solution. This includes the pay-to-platform ratio, assuming a user-defined deadhead on the pull-out and pull-in of each run.

Once the driver shifts are completed, they are then assembled into biddable/assignable pieces of work by the rostering tool (136). Using the above parameters and the runs and driver shifts generated by the blocking and run-cutting tool, the rostering tool uses logic to produce a paratransit service schedule including driver shifts. In traditional scenarios, each piece of work consists of either a single straight driver shift or two split driver shifts. The information for each driver shift includes the start time and end time for each day of the week. The roster consists of recommended biddable pieces of work.

The inputs obtained at this stage are:
the minimum percent of straight driver shills (which is equal to the maximum percent of split driver shifts)
which split types can be combined; for example, can a piece of work be made up of two “Split 5” driver shifts?
the maximum spread time allowed, measured from the first run pull-in to the second run pull-out and/or measured from the first run pull-out to the second run pull-in
the maximum number or percent of split driver shifts that can be created as part-time driver shifts, meaning they are not combined with any other driver shift to make a full-time driver piece of work.
   These inputs are stored in a configuration file in storage.

Once the runs and driver shifts are assembled at 132 and roistered at 136, output is generated (step 140). In particular, the paratransit service scheduling software stores the service schedule in storage of the computer system 20. The user interface permits review of the run-cut results and approval thereof. The service of the paratransit service scheduling software permits interfacing directly with a commercial paratransit scheduling system to import the resulting runs for the purpose of validating the results by rescheduling the trips on the selected schedule day against the revised run profile. In addition, the paratransit service scheduling software also generates a set of runs in both graphical and tabular format that can be used for manually establishing runs in another commercial paratransit scheduling system that does not support the service, if so desired.

Once output is generated, the method 100 ends.

While the invention has been described with specificity to a certain approach, those of skill in the art will appreciate that variations to the approach described above can be used without departing from the spirit of the invention. For example, the best day for modeling service can be selected from the set of past days by considering one or more of how well the past day matches the target demand level and the general demand pattern for past days of the same day type, and the magnitude of the service fit metrics. It can be desirable in some circumstances to select a past day whose actual service provided fairly closely matched demand for that day.

The demand analysis tool can be used to select a particular past day upon which to model service in other ways. For example, the demand analysis tool can automatically select a past day in the set of past days best matching the target demand level. Once the past day is selected, the demand analysis tool can compare the demand pattern over the course of the selected past day to the general demand pattern for the average of the set of past days using some type of fit test, such as a least-squares approach. If the demand distribution for the selected past day is deemed to generally match the general demand pattern of the average of the set of past days (or some other distribution), the demand analysis tool can proceed with the selected past day. If, instead, the demand distribution for the selected past day does not match that of the average of the set of past days satisfactorily, another past day in the set can be selected for analysis. The past days can be selected for analysis based on having demand metrics that are closest to the target demand level or are closest and lower, or over, the target demand level.

Computer-executable instructions for carrying out the inventive method on a computer system could be provided separately from the computer system, for example, on a computer-readable medium (such as, for example, an optical disk, a hard disk, a USB drive or a media card) or by making them available for downloading over a communications network, such as the Internet.

While the term “tool” is used in the description above, those skilled in the art will appreciate that any combination of software, firmware and/or hardware that provides the required functionality fall within the scope of the term. Further, one or more of these tools can be split apart or merged.

While the computer system is shown as a single physical computer, it will be appreciated that the computer system can include two or more physical computers in communication with each other. Accordingly, while the embodiment shows the various components of the stateful data sharing service residing on the same physical computer, those skilled in the art will appreciate that the components can reside on separate physical computers. Further, any or all of the components of the stateful data sharing service can reside on a separate physical computer from the software systems.

The blocking and run-cutting can be performed sequentially instead of together.

The above-described embodiments are intended to be examples of the present invention and alterations and modifications may be effected thereto, by those of skill in the art, without departing from the scope of the invention that is defined solely by the claims appended hereto.

What is claimed is:

1. A method for scheduling paratransit service, comprising:
identifying demand metrics in a database for a set of past days matching the type of a day for which service is being planned, said database being stored in storage of a computer system;
selecting one of said set of past days whose demand metrics correspond to a target demand level to be satisfied;
initializing a service schedule for said day using actual service provided for said one past day stored in said database;
adjusting said service schedule for service fit metrics for said one past day stored in said database; and
outputting said service schedule for said day.

2. The method of claim 1 wherein said demand metrics include the number of passenger pick-ups and drop-offs.

3. The method of claim 1, wherein said service fit metrics comprise lateness metrics.

4. The method of claim 3, wherein said lateness metrics include late pick-up events.

5. The method of claim 3, wherein said lateness metrics include late drop-off events.

6. The method of claim 1, wherein said service fit metrics comprise slack metrics.

7. The method of claim 6, wherein said slack metrics include the amount of vehicle idle time.

8. The method of claim 1, further comprising:
adjusting further said schedule for expected growth.

9. The method of claim 1, wherein said selecting comprises:
selecting said one past day at least partially based on a fit level between said demand metrics for said one past day and a general demand pattern for the type of said day.

10. The method of claim 9, wherein said general demand pattern corresponds to the average of said demand metrics for said set of past days.

11. The method of claim 1, further comprising:
discarding said selected one past day if a fit level between said demand metrics for said selected one past day and a general demand pattern for the type of said day is unsatisfactory; and
selecting a remaining one of said set of past days whose demand metrics correspond to a target demand level to be satisfied.

12. The method of claim 1, wherein said target demand level to be satisfied corresponds to a desired ratio of the time for which all expected demand is met.

13. The method of claim 1, wherein holidays are excluded from said set of past days.

14. A system for scheduling paratransit service, comprising:
a database stored in storage of a computer system, said database storing demand metrics and service data for past days, said service data including actual service provided and service fit metrics; and
service scheduling software executing on said computing system, said service scheduling software identifying said demand metrics in said database for a set of said past days matching the type of a day for which service is being scheduled, mapping a target demand level to be satisfied onto said demand metrics for said set of past days, initializing a service schedule for said day using said actual service provided stored in said database for a selected past day whose demand metrics generally correspond to said target demand level, adjusting said service schedule for said service fit metrics and slack metrics for said one past day stored in said database, and outputting said service schedule for said day.

15. The system of claim 14, wherein said demand metrics include the number of passenger pick-ups and drop-offs.

16. The system of claim 14, wherein said service fit metrics comprise lateness metrics.

17. The system of claim 16, wherein said lateness metrics include late pick-up events.

18. The system of claim 16, wherein said lateness metrics include late drop-off events.

19. The system of claim 14, wherein said service fit metrics comprise slack metrics.

20. The system of claim 19, wherein said slack metrics include the amount of vehicle idle time.

21. The system of claim 14, wherein said service scheduling software adjusts said service schedule for expected growth.

22. The system of claim 14, wherein said service scheduling software selects said one past day at least partially based on a fit level between said demand metrics for said one past day and a general demand pattern for the type of said day.

23. The system of claim 22, wherein said general demand pattern corresponds to the average of said demand metrics for said set of past days.

24. The system of claim 14, wherein said service scheduling software discards said selected one past day if a fit level between said demand metrics for said selected one past day and a general demand pattern for the type of said day is unsatisfactory, and selects a remaining one of said set of past days whose demand metrics correspond to a target demand level to be satisfied.

25. The system of claim 14, wherein said target demand level to be satisfied corresponds to a ratio of the time for which all expected demand is met.

26. The system of claim 14, wherein holidays are excluded from said set of past days.
